(19) United States
(12) Patent Application Publication
(10) Pub. No.: US 2011/0084030 A1
(43) Pub. Date: Apr. 14, 2011

(54) METHOD AND SYSTEM FOR MONITORING AND/OR TRACKING SODIUM HYPOCHLORITE USE

(75) Inventors: Mark B. NELSON, Orinda, CA (US); Michael Townsend, Clayton, CA (US); Michael Ray Donn, Concord, CA (US); John Galloway, Walnut Creek, CA (US)

(73) Assignee: FORCE FLOW, Concord, CA (US)

(21) Appl. No.: 12/902,470

(22) Filed: Oct. 12, 2010

Related U.S. Application Data
(60) Provisional application No. 61/250,706, filed on Oct. 12, 2009.

(51) Int. Cl. C02F 1/76; F17D 3/00

(52) U.S. Cl. 210/744; 137/552; 137/1

(57) ABSTRACT

A method of monitoring sodium hypochlorite usage, which includes providing a chemical system comprising: a tank of known capacity mounted upon a scale, the scale being capable of generating a series of signals related to the weight of the tank when empty and at various levels of fill; and a system controller for receiving the series of signals from the scale relating to the weight of the tank when empty and at various levels of fill; inputting into the system controller the series of signals from the scale relating to the weight of the tank when empty and at various levels of fill with sodium hypochlorite; inputting into the system controller a concentration of the sodium hypochlorite upon filling of the tank; tracking an age of the sodium hypochlorite within the tank to obtain a percent concentrate of sodium hypochlorite; and displaying usage of sodium hypochlorite on a display.

### CROSS-REFERENCE TO RELATED APPLICATION

This patent application claims priority to U.S. Provisional Patent Application Ser. No. 61/250,706, filed Oct. 12, 2009, which is incorporated herein by reference in its entirety.

### TECHNICAL FIELD

This invention relates to a method and system for monitoring and/or tracking sodium hypochlorite use, and more particularly to a method and system for monitoring and/or tracking sodium hypochlorite use in chlorination of swimming pool, drinking water and/or waste water treatment facilities (i.e., a water process).

### BACKGROUND

Sodium Hypochlorite (Bleach) is a liquid chemical that is used for many disinfection applications including the disinfection of public water supplies. Over the past 5-10 years, sodium hypochlorite has become more popular for water disinfection due to the regulatory and safety concerns surrounding the use of chlorine gas. The feeding of chlorine gas is a technology that was perfected over almost 100 years, and has been favored because it is economical, simple and reliable. Chlorine gas is 100% pure, has an unlimited shelf life, and is easy to feed because it is chemically stable and has a consistent strength.

Sodium hypochlorite does not exhibit any of the above qualities and therefore has presented many challenges and problems for the user. First, sodium hypochlorite is manufactured and sold in various strengths and therefore is not as simple to track inventory or document true daily chemical usage because you need to know both quantity and concentration. In addition, sodium hypochlorite degrades as it ages depending on time, temperature, and beginning sodium hypochlorite strength making inventory control and usage documentation even trickier. Secondly, when sodium hypochlorite degrades, it releases gas bubbles that can often be trapped in feed tubing and pumps causing inconsistent feed and in some cases a “vapor lock” of the pump itself. Vapor locking happens when enough gas bubbles form in the pump that cause it to lose prime and thus cease functioning. This is particularly critical in municipal water treatment systems where the sodium hypochlorite is being used to disinfect the water supply. Lastly, as sodium hypochlorite degrades over time, it forms byproducts called chlorates. Chlorates are known to impair thyroid function, and therefore regulatory officials are beginning to regulate how much chlorate can be in the water supply, and more specifically, how much chlorate can be contributed to the water supply from the source sodium hypochlorite.

### SUMMARY OF THE INVENTION

The above problems associated with the use of sodium hypochlorite in municipal water treatment systems can be managed and controlled manually by vigilant treatment plant operators, however, the need for a simple fully integrated product that can automatically assist the operator in monitoring these various problems would be of great use. In accordance with an exemplary embodiment, this invention encompasses a digital display that can be connected to an electronic weighing scale or ultrasonic level sensor, which by integrating specialized software to a weighing system and system controller, the operator can: (1) track or monitor an inconsistent or no feed rate condition via loss in weight (or level) to warn of a vapor locked pump; (2) determine an age of the sodium hypochlorite to warn of an excessive chlorate condition; (3) track sodium hypochlorite strength over time as sodium hypochlorite loses strength by implementation and/or use of degradation curves; and (4) allow the operator to view & track sodium hypochlorite in terms of 100% pure chlorine gas to simplify inventory control and usage documentation.

In accordance with an exemplary embodiment, a method of feeding sodium hypochlorite to a water process comprises: providing a chemical system comprising: a chemical storage tank having a source of sodium hypochlorite; a metering pump used to feed the sodium hypochlorite to a water process; tracking an age of the source of sodium hypochlorite within the storage tank to obtain a percent concentrate of sodium hypochlorite; feeding the sodium hypochlorite to a water process; and increasing a speed of the metering pump to compensate for degradation of the sodium hypochlorite within the bulk tank. In accordance with an exemplary embodiment, the method also includes sending a signal to the metering pump to increase the speed of the metering pump to compensate for the degradation of the sodium hypochlorite within the chemical storage tank, and using a multi-point sodium hypochlorite degradation curve to track the age of the sodium hypochlorite with the chemical storage tank.

In accordance with a further exemplary embodiment, a method of monitoring sodium hypochlorite usage comprises: providing a chemical system comprising: a tank of known capacity, the supply tank located upon a scale, the scale being capable of generating a series of signals related to the weight of the tank when empty and at various levels of fill; and a system controller for receiving the series of signals from the scale relating to the weight of the tank when empty and at various levels of fill; inputting into the system controller the series of signals from the scale relating to the weight of the tank when empty and at various levels of fill with sodium hypochlorite; inputting into the system controller a concentration of the sodium hypochlorite upon filling of the tank; tracking an age of the sodium hypochlorite within the tank to obtain a percent concentrate of sodium hypochlorite; and displaying usage of sodium hypochlorite on a display of the system controller.

In accordance with another exemplary embodiment, a system for monitoring sodium hypochlorite usage comprises: a tank of known capacity, the tank located upon a scale, the scale being capable of generating a series of signals related to the weight of the tank when empty and at various levels of fill; and a system controller having a display for displaying sodium hypochlorite usage, and wherein the system controller performs the following steps: inputting into the system controller the series of signals from the scale relating to the weight of the tank when empty and at various levels of fill with sodium hypochlorite; inputting into the system controller a concentration of the sodium hypochlorite upon filling of the tank; tracking an age of the sodium hypochlorite within the tank to obtain a percent concentrate of sodium hypochlorite; and displaying usage of sodium hypochlorite on a display of the system controller.

In accordance with a further exemplary embodiment, a computer readable medium containing a computer program for monitoring sodium hypochlorite usage, wherein the computer program comprises executable instructions for: providing a chemical system comprising: a tank of known capacity, the supply tank located upon a scale, the scale being capable of generating a series of signals related to the weight of the tank when empty and at various levels of fill; and a system controller for receiving the series of signals from the scale relating to the weight of the tank when empty and at various levels of fill; inputting into the system controller the series of signals from the scale relating to the weight of the tank when empty and at various levels of fill with sodium hypochlorite; inputting into the system controller a concentration of the sodium hypochlorite upon filling of the tank; tracking an age of the sodium hypochlorite within the tank to obtain a percent concentrate of sodium hypochlorite; and displaying usage of sodium hypochlorite on a display of the system controller.

In accordance with another exemplary embodiment, a method of monitoring sodium hypochlorite usage, comprises: providing a chemical system comprising: a tank of known capacity; and a system controller for receiving the series of signals from an ultrasonic level sensor relating to various levels of fill of the tank; inputting into the system controller the series of signals from the scale relating to the various levels of fill of the tank with sodium hypochlorite; inputting into the system controller a concentration of the sodium hypochlorite upon filling of the tank; tracking an age of the sodium hypochlorite within the tank to obtain a percent concentrate of sodium hypochlorite; and displaying usage of sodium hypochlorite on a display of the system controller.

### BRIEF DESCRIPTION OF THE DRAWINGS

FIG. 1 is an elevation view of a system for monitoring and tracking chemical usage in a municipal water facility in accordance with an exemplary embodiment.

FIG. 2 is a schematic view of the component layout of a controller used in the system and method of the present invention in accordance with another exemplary embodiment.

FIG. 3 is an elevation view of a system for monitoring and tracking chemical usage in a municipal water facility in accordance with another exemplary embodiment.

FIG. 4 is a schematic view of a display of a controller in accordance with an embodiment.

FIG. 5 is a schematic view of a display of a controller in accordance with another embodiment.

FIG. 6 is a schematic view of a display of a controller in accordance with an embodiment.

FIG. 7 is a schematic view of a display of a controller in accordance with another embodiment.

FIG. 8 is a schematic view of a display of a controller in accordance with an embodiment.

FIG. 9 is a schematic view of a display of a controller in accordance with another embodiment.

FIG. 10 is a schematic view of a display of a controller in accordance with an embodiment.

FIG. 11 is a schematic view of a display of a controller in accordance with another embodiment.

FIG. 12 is a schematic view of a display of a controller in accordance with an embodiment.

FIG. 13 is a schematic view of a display of a controller in accordance with another embodiment.

FIG. 14 is a schematic view of a display of a controller in accordance with an embodiment.

FIG. 15 is a schematic view of a display of a controller in accordance with another embodiment.

FIG. 16 is a schematic view of a display of a controller in accordance with an embodiment.

FIG. 17 is a chart showing degradation of sodium hypochlorite over time.

### DETAILED DESCRIPTION

The system and the method of its use will be described in the context of sodium hypochlorite as the gas or chemical. However, it can be appreciated that these materials are not limiting and that this system and its use could work with a wide variety of gases and chemicals having similar properties to that of sodium hypochlorite.

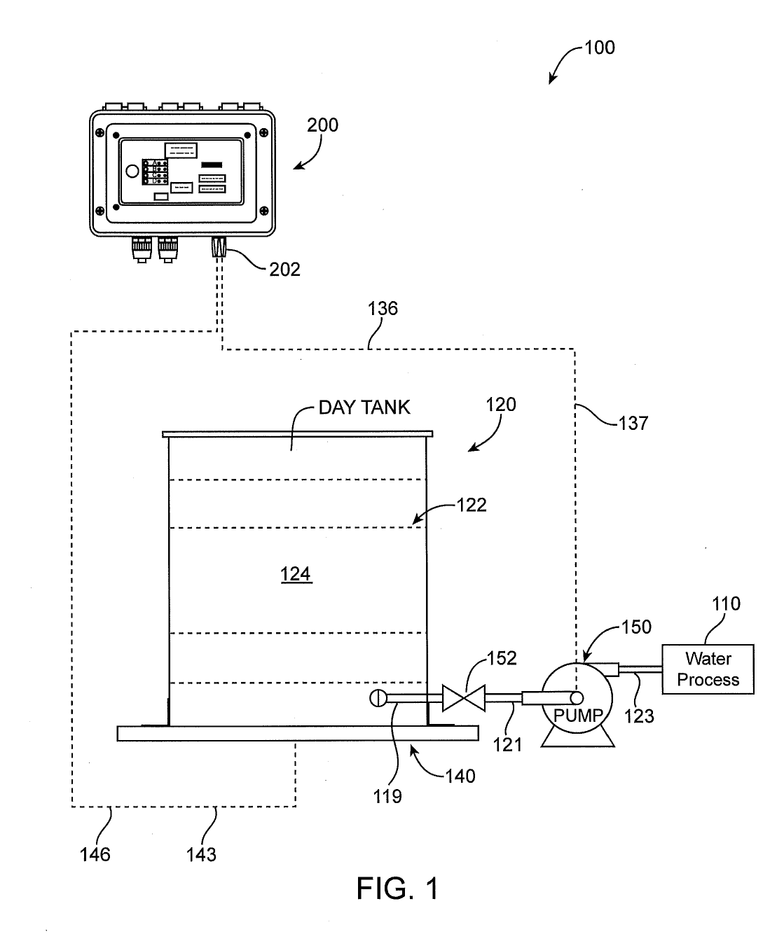

FIG. 1 shows an exemplary embodiment of system 100 for sodium hypochlorite, which includes a supply tank (or chemical storage tank) 120, which provides a variable quantity 122 of sodium hypochlorite 124 to a water process 110. The supply tank 120, which is also know as a day tank, tote or drum, preferably has a known capacity, and in accordance with an exemplary embodiment is preferably supported on and/or mounted upon a scale 140, which is capable of generating a series of signals 143 related to the weight of the tank 120 when empty and at various levels of fill. It can be appreciated that the supply tank 120 can be any suitable source of sodium hypochlorite, including drums or totes. In accordance with an exemplary embodiment, the supply tank 120 is a standalone tank, drum or tote, wherein the supply tank 120 is not connected or associated with a bulk tank (130 as shown in FIG. 3).

The tank 120 is preferably vertical tanks designed to hold a chemical, such as sodium hypochlorite 124 used in the treatment of water or wastewater (i.e., a water process). However, the type of tank is not limiting and the system and methods according to this invention can be used with a variety of tanks, drums and/or totes. In addition, as indicated above, the system 100 is not limited to the treatment of water or wastewater and the system and its use can work with a wide variety of applications wherein gas or chemical detection and display of the amount of gas or chemical remaining in the vessel is needed.

As shown in FIG. 1, the supply tank 120 supplies chemicals in the form of sodium hypochlorite 124 through an exit line 119 to a first valve 152 and through line 121 to a chemical feed flow controller or metering pump 150 for controlling the flow of sodium hypochlorite 124 from the supply tank 120 to the water process 110. The chemical feed flow controller or metering pump 15 can be any suitable pump or motorized ball valve system used to deliver chemical to a water process. In a typical municipal chemical feed application, sodium hypochlorite 124 is fed out of the supply tank 120 (also known as a day tank) on a 24-hour, 7 day a week schedule. The supply tank or “day tank” 120 is typically in the 50 to 5000 gallon range for municipal water facilities depending on the plant capacity and water system being treated. However, it can be appreciated that the system and methods described herein can be utilized using tanks 120 having larger or smaller capacities than recited herein.

The supply tank 120 is preferably equipped with a series of relays 170, which correspond to a series of usage and/or filling reference points. The first relays corresponds to a “low level alarm”; the second relay corresponds to a high level alarm, the third relay corresponds to a “high chlorate condition”, and the fourth relay corresponds to a “vapor locked pump” or “no feed rate condition”.

As shown in FIG. 1, the supply tank 120 is supported on an electronic scale 140 in the form of a platform or chemical scale, which generates a series of electronic signals 143, which are transmitted to the system controller 200 via the controller line 146. The electronic signals 143 include information related to the empty weight, full weight and partially full weight of the supply tank 120. The moveable electronic scale 140 typically includes a platform member 142 configured to support the supply or day tank 120. In operation, an electronic load cell or hydraulic cell (not shown) generates an electronic signal 143, which is a function of the variable quantity 122 of sodium hypochlorite 124 in the supply tank 120.

It can be appreciated that although as shown in FIG. 1, the system including a supply tank 120, the system and methods as described herein can be extended to an any suitable scale 140, which includes electronic scales, hydraulic scales and/or an ultrasonic level sensor (FIG. 3), which each produces a signal 143, which is sent to the system controller 200 via line 146.

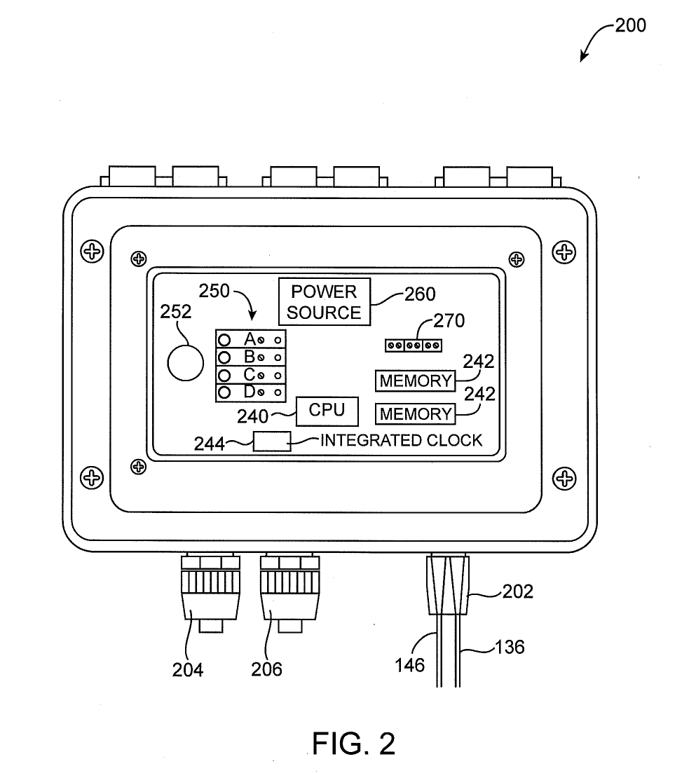

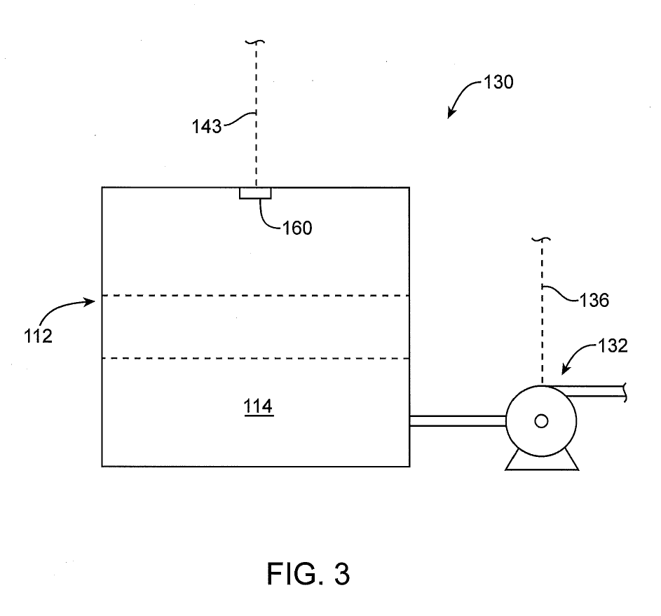

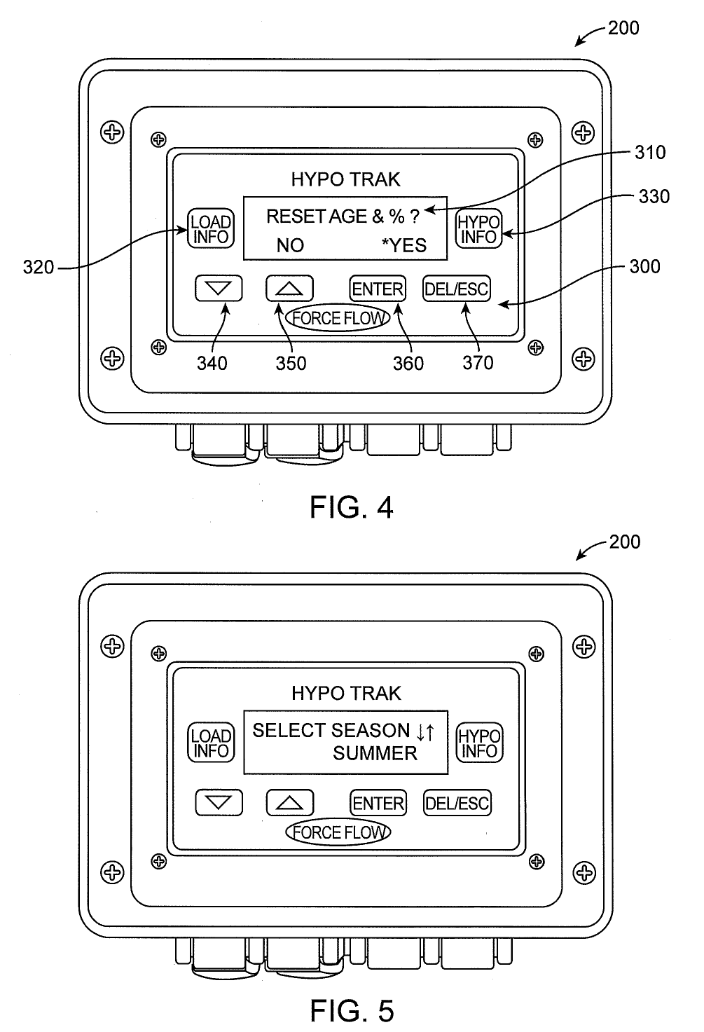

As shown in FIG. 2, the system controller 200 receives the electrical signal and converts the electrical signal via a microprocessor CPU 240 to a displayable user interface or digital display 310 (FIG. 4). The system controller 200 preferably includes a microprocessor CPU 240, memories 242, and relays 250. In accordance with an exemplary embodiment, the microprocessor 240 (CPU) converts the electrical signal into a displayable signal indicative of an amount of supply tank 120. The system controller uses AC voltage 260 (120/240 volt) to operate. In addition, it can be appreciated that the system controller 200 can be configured to reduce voltage necessary to operate the 4-20 mA loops and the load cell excitation.

An integrated time clock 244 within the system controller 200 allows computation of “loss in weight” feed rates and daily chemical/gas usage data. In one embodiment, the system controller 200 includes a 4-20 mA output signal 270 capable of remotely transmitting remaining chemical, and chemical feed rates. In addition, the system controller 200 can also include a hi/lo level dry relay 252 for remotely alarming remaining chemical, high chlorate warning, or vapor locked pump/no feed rate condition.

The system controller 200 is preferably a hermetically sealed polypropylene case with front cam lock bezel and having a plurality of connectors 202, 204, 206, which include connector 202, which is configured to receive connector lines 136, 146. The system controller 200 includes a standard case connection for cable or wiring, which is preferably a standard plastic, and a compression fitting. However, it can be appreciated that other connections can be used as known to one skilled in the art. The system controller 200 will also preferably have a non-volatile memory 242. Accordingly, if the system controller 200 is turned off or power is disconnected for any reason, stored parameters will be saved in memory 242.

In accordance with another exemplary embodiment, as shown FIG. 3, the system and methods as described herein can also be applied to a bulk tank 130, which supplies chemical in the form of sodium hypochlorite 114 to a supply tank (or chemical supply tank) 120 (as shown in FIG. 1) via a transfer pump 132. The transfer pump 132 is preferably connected to the system controller 200 via connector line 136. It can be appreciated that the controller line 136 sends a series of signals to the transfer pump 132 to control pump speed and other related pump functions. In accordance with an exemplary embodiment, the bulk tank 130 (or supply tank 120) includes an ultrasonic level sensor 160, which generates a series of electronic signals 143, which are transmitted to the system controller 200 related to chemical levels 112 within the bulk tank 130 at various levels of fill. It can be appreciated that the supply tank (chemical supply tank, etc.) 120 as shown in FIG. 1 can also be fitted with an ultrasonic level sensor 160 instead of an electronic and/or hydraulic platform system 140.

In accordance with another exemplary embodiment, the system controller 200 as shown in FIGS. 4-16 includes a display 300 having a user interface or digital display 310, which can include a “load hypo” key (or load key 320), a “hypo info” key (or information key) 330, a down arrow (or decrease) key 340, an up arrow (or increase) key 350, an enter key 360 and a “del/esc” (i.e., delete/escape or cancel) key 370. It can be appreciated that the down arrow is for scrolling “down”; the up arrow for scrolling “up”; the “del/esc” button for deleting selected items or escaping from certain selected menu items; and the “enter” button allows for saving a selected item to memory.

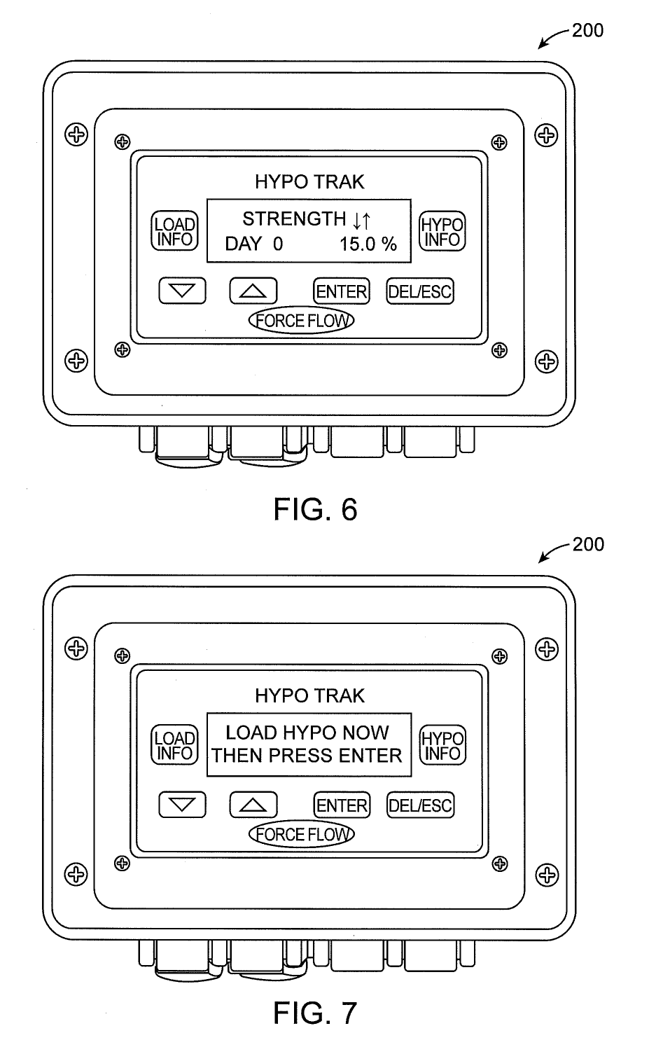

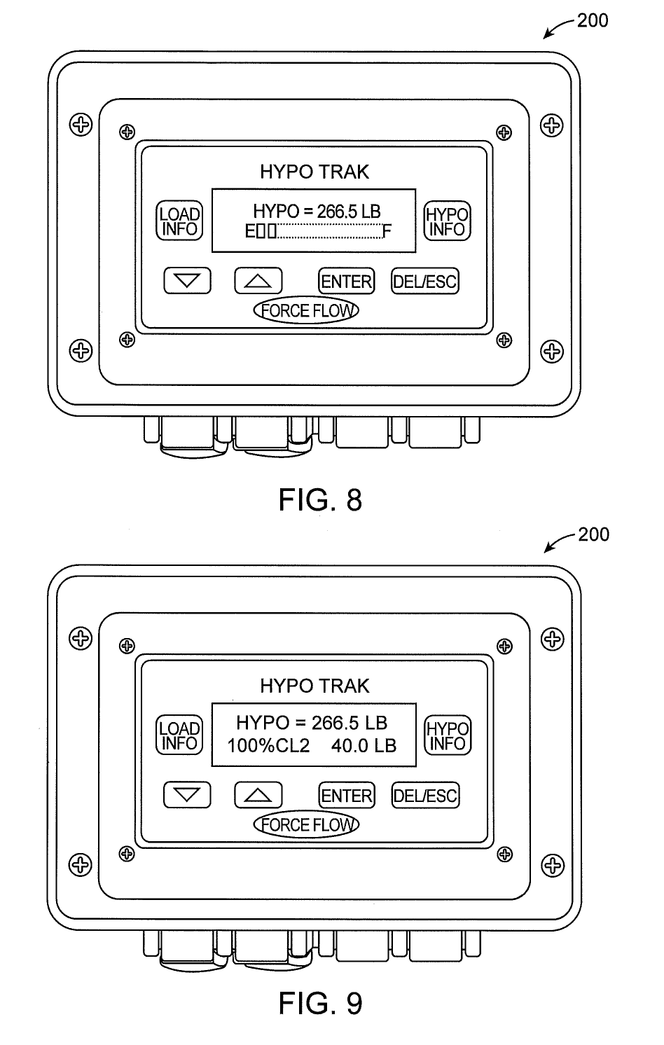

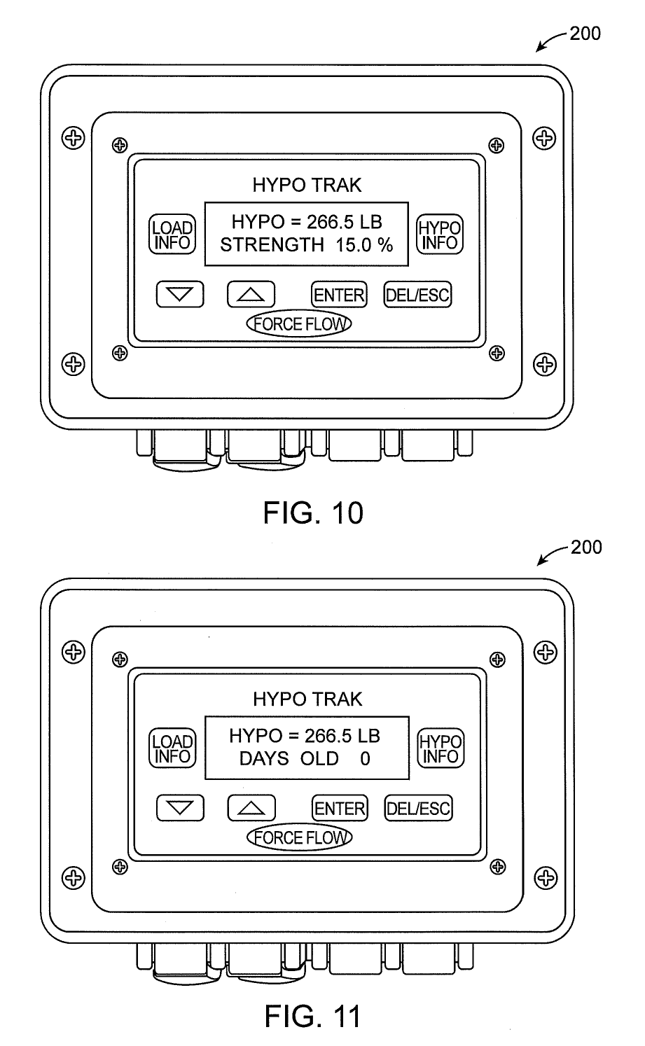

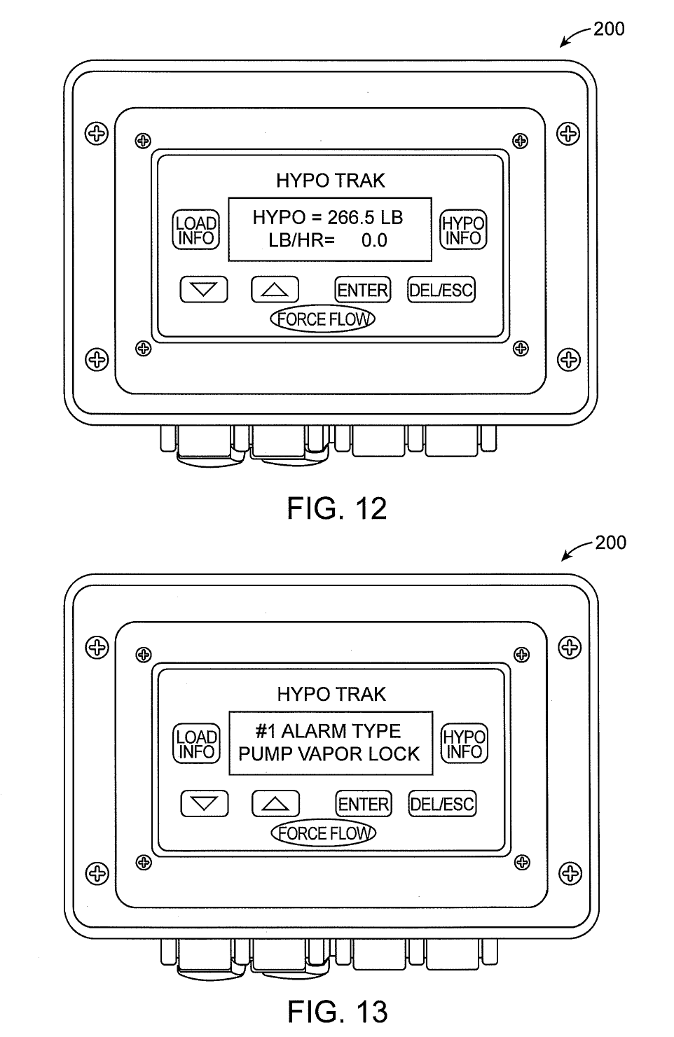

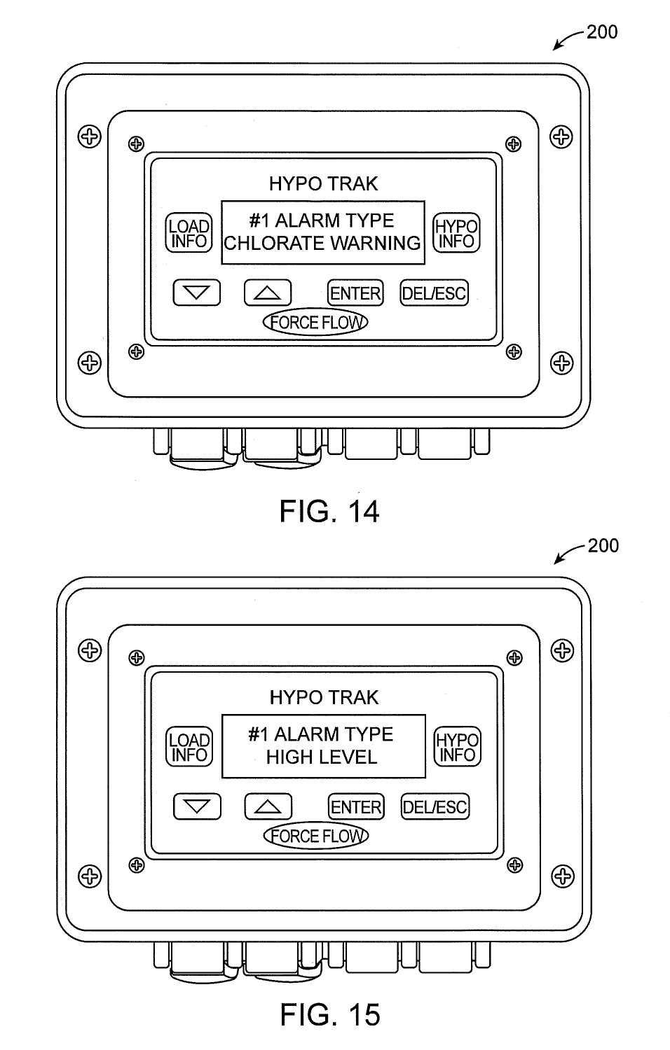

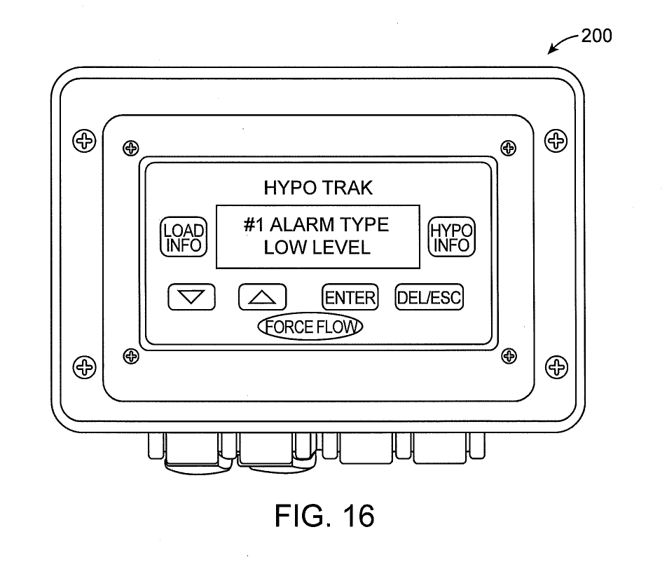

In accordance with an exemplary embodiment, the user interface or digital display 310 displays a series of readings including but not limited to: “Reset Age & %?” with a “No” and “Yes” indicator (FIG. 4); “Select Season ↓↑” with a Summer, Winter or Mild display (FIG. 5); “Strength ↓↑” and “Day 0 15.0%” (FIG. 6); “Load Hypo Now” and “Then Press Enter” (FIG. 7); “Hypo=266.5 LB” with a bar chart extending from E (or empty) to F (or Full) (FIG. 8); “Hypo=266.5 LB” with a percentage of Chlorine (or Cl₂) and weight (i.e., 40.0 LB) (FIG. 9); “Hypo=266.5 LB” with a strength/percentage (i.e., “Strength 15.0%”) (FIG. 10); “Hypo=266.5 LB” with “Days Old 0” (FIG. 11); “Hypo=266.5 LB” with “LB/HR=0” (FIG. 12); “#1 Alarm Type” with “Pump Vapor Lock” (FIG. 13); “#1 Alarm Type” with “Chlorate Warning” (FIG. 14); “#1 Alarm Type” with “High Level” (FIGS. 15); and “#1 Alarm Type” with “Low Level” (FIG. 16).

It can be appreciated that in addition to the above-mentioned series of readings, the digital display 310 on the system controller can provide readings related to daily usage, days until empty, chemical feed rates, and other related readings. It can be appreciated that the display 210 can allow the user to monitor chemicals in Lbs (pounds), Kgs (kilograms), Gallons, Liters and/or Percent of Full. In addition, the system controller 200 allows the operator to monitor chemical feed rates, which can be alarmed or transmitted via a 4-20 ma signal 270.

### Vapor Lock Alarm Function:

It can be appreciated that calculating a given weight loss over a specific time period allows the operator or user to detect a low or zero feed rate condition (i.e., a vapor lock). Accordingly, it would be desirable to use a loss in weight (level) feed rate function to monitor a vapor locked pump in a chemical feed system as shown in FIG. 1. It can be appreciated that since disinfecting a water supply is a 24/7/365 job (i.e., 24 hours a day/7 days a week/and 365 days a year), it is necessary to resupply the sodium hypochlorite to the supply tank 120 while continuing to feed to the water supply with sodium hypochlorite from the supply tank 120.

When a supply tank (or sodium hypochlorite tank) 120 is resupplied, it can be refilled from a bulk tank, a delivery truck, or alternatively, the supply tank (or sodium hypochlorite tank) 120 can have an empty drum or tote replaced with a full one. In either case, the weight (or level) will have a drastic change during this resupply, and therefore the resupply function of the system controller 300 must be recognized as such and not a vapor locked pump. In accordance with an exemplary embodiment, this recognition of a resupply can be accomplished via a “load hypo” key 320 on the display 310 of the system controller 300, which allows the operator to pause a feed rate value within the system controller 200 prior to initiating the refilling (i.e., resupply) of the sodium hypochlorite tank 120, and then resuming the prior feed rate value after resupply is complete.

Excessive Chlorate Alarm Function:

In accordance with another exemplary embodiment, the system controller 200 includes a chlorate alarm function, which tracks the age of the sodium hypochlorite 124 to obtain an estimate of how much chlorate has formed in the source sodium hypochlorite supply. As set forth above, when sodium hypochlorite 124 degrades, it releases gas bubbles that can often be trapped in feed tubing and pumps causing inconsistent feed and in some cases a “vapor lock” of the pump itself. It can be appreciated that vapor locking occurs when enough gas bubbles form in the pump, and causing the pump to lose prime and thus ceases functioning. This is particularly critical in municipal water treatment systems where the sodium hypochlorite 124 is used to disinfect the water supply.

In accordance with an exemplary embodiment, the excessive chlorate alarm function incorporates the “load hypo' key like the above feature (i.e., vapor lock alarm function), and resets the age to 0 days when the new sodium hypochlorite is loaded or placed within the supply tank 120. The user or operator resets an alarm in the alarm menu within the digital display 310 by specifying a time period at which an excessive chlorate condition is expected to be reached. It can be appreciated that the time period at which an excessive chlorate condition is expected to be reached can be based on at least some or all of the following conditions, the amount of sodium hypochlorite, the age of the sodium hypochlorite, the strength of the sodium hypochlorite, and/or average temperature conditions upon which the sodium chlorite and supply tank 120 resides. For example, sodium hypochlorite is preferably stored no more than 75 days, however, it can be appreciated that the period of storage can vary depending on the season and associated weather conditions, such that sodium hypochlorite should not be stored more than 50 day during the summer and 125 days during winter as examples thereof. In general, the rate of degradation of sodium hypochlorite increases with heat and sunlight.

Multi Point Degradation Curve:

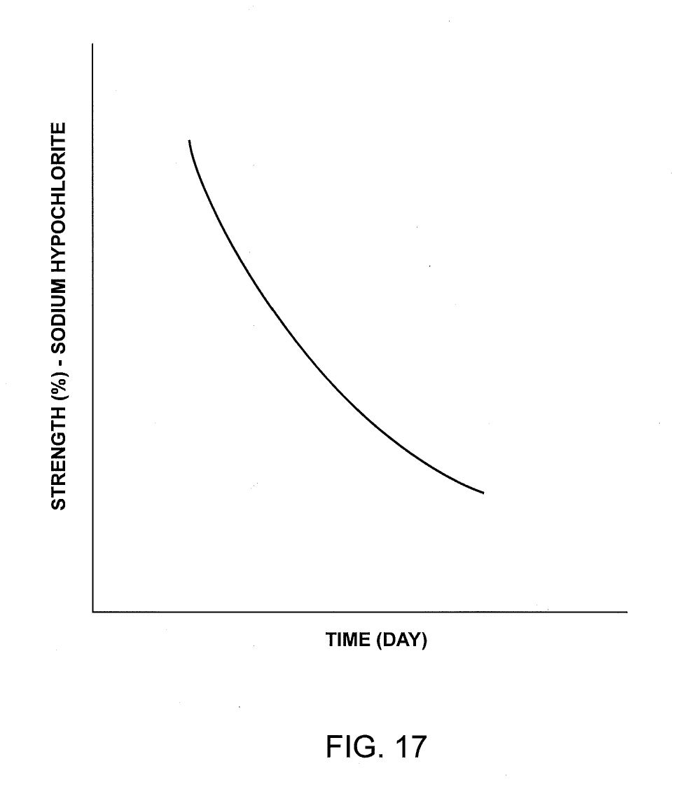

In accordance with another exemplary embodiment, the system controller 200 includes the ability to impart to the operator the strength of the sodium hypochlorite 124 at any given time, by allowing the user (or operator) to build or generate, and store a plurality (i.e., at least two or more) of custom sodium hypochlorite degradation curves for seasons such as Winter, Spring, Summer and Fall, and variations thereof including Mild, Severe and/or Norm conditions. It can be appreciated that the degradation curves (such as shown in FIG. 17) can be generated based on the initial strength, average temperature conditions, time that the user or operators stores the sodium hypochlorite, and amount of sunlight exposure.

In accordance with an exemplary embodiment, the user or operator can build up to 10 different slopes into a single curve and test periods of up to 99 days each. It can be appreciated that this flexibility is useful in tracking the strength of sodium hypochlorite because sodium hypochlorite does not degrade in a straight line. Rather, sodium hypochlorite degrades slower as it gets older. It can be appreciated that the “Load Hypo” key 320 can be used again with this feature as it prompts the user or operator to input the beginning strength of sodium hypochlorite that was delivered during the resupply process.

In addition, it can be appreciated that as the sodium hypochlorite degrades, it is necessary for operators to increase the amount of sodium hypochlorite 124 fed from the supply tank 120 to the water process 110 in order to maintain the same level of disinfection. Typically, an operator must manually increase the metering pump speed 150 over time to accommodate for the degradation of the sodium hypochlorite. However, with the use of the multipoint degradation curve, the system controller 200 can be configured to automatically increase the speed of the metering pump 150 by an amount necessary to compensate for the loss in strength of the sodium hypochlorite. In accordance with an exemplary embodiment, by sending a 4-20 ma output to the metering pump 150, the system controller 200 can be configured to automatically increases the metering pump 150 speed as the sodium hypochlorite degrades over time. For instance, if the sodium hypochlorite degrades from 10% to 9% (a total of a 10% decrease in overall strength) over a 1-week period, the system controller 200 can increase the metering pump speed by 10% over the same period to compensate for the loss in sodium hypochlorite strength. It can be appreciated that this feature saves time and labor by keeping operators from having to manually adjust their pumps 150 as the sodium hypochlorite decreases in strength.

Conversion to 100% Pure Chlorine:

Since users have become accustomed to viewing their chlorine gas inventory and usage in terms of 100% pure Chlorine (Cl₂) gas, it is confusing when converting to sodium hypochlorite especially when the sodium hypochlorite is not a consistent strength from day to day. It can be appreciated that just knowing the level or weight of what is in their chemical tank is no longer sufficient. The user must know the level or weight and the percent concentration to be able to identify true inventory or true daily usage. With the assistance of the multipoint degradation curve, the system controller 200 automatically makes the calculations to display the inventory in terms of 100% pure chlorine gas. It can be appreciated that in accordance with an exemplary embodiment, a single “load hypo” key 320, which allows the user to gain four key pieces of information through one simple routine when loading sodium hypochlorite, can be desirable.

In accordance with another exemplary embodiment, a computer readable medium containing a computer program for monitoring sodium hypochlorite usage, wherein the computer program comprises executable instructions for: providing a chemical system comprising: a tank of known capacity, the supply tank mounted upon an electronic scale, the scale being capable of generating a series of signals related to the weight of the tank when empty and at various levels of fill; and a system controller for receiving the series of signals from the scale relating to the weight of the tank when empty and at various levels of fill; inputting into the system controller the series of signals from the scale relating to the weight of the tank when empty and at various levels of fill with sodium hypochlorite; inputting into the system controller a concentration of the sodium hypochlorite upon filling of the tank; tracking an age of the sodium hypochlorite within the tank to obtain a percent concentrate of sodium hypochlorite; and displaying usage of sodium hypochlorite on a display of the system controller.

The computer readable medium, of course, may be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if embodiment of the present invention is combination of software and hardware, it does not deviate from the concept of the invention at all. The present invention may be implemented such that its software part has been written onto a recording medium in advance and will be read as required in operation.

While this invention has been described with reference to the preferred embodiment described above, it will be appreciated that the configuration of this invention can be varied and that the scope of this invention is defined by the following claims.

What is claimed is:

1. A method of feeding sodium hypochlorite to a water process, comprising:
providing a chemical system comprising:
a chemical storage tank having a source of sodium hypochlorite; and
a metering pump used to feed the sodium hypochlorite to the water process;
tracking an age of the source of sodium hypochlorite within the tank to obtain a percent concentrate of sodium hypochlorite;
feeding the sodium hypochlorite from the chemical storage tank to the water process via the metering pump; and
increasing a speed of the metering pump to compensate for degradation of the sodium hypochlorite within the chemical storage tank.

2. The method of claim 1, further comprising sending a signal to the metering pump to increase the speed of the metering pump to compensate for the degradation of the sodium hypochlorite within the chemical storage tank.

3. The method of claim 1, further comprising using a multi-point sodium hypochlorite degradation curve to track the age of the sodium hypochlorite with the chemical storage tank.

4. A method of monitoring sodium hypochlorite usage, comprising:
providing a chemical system comprising:
a tank of known capacity, the tank located upon a scale, the scale being capable of generating a series of signals related to the weight of the tank when empty and at various levels of fill; and
a system controller for receiving the series of signals from the scale relating to the weight of the tank when empty and at various levels of fill;
inputting into the system controller the series of signals from the scale relating to the weight of the tank when empty and at various levels of fill with sodium hypochlorite;
inputting into the system controller a concentration of the sodium hypochlorite upon filling of the tank;
tracking an age of the sodium hypochlorite within the tank to obtain a percent concentrate of sodium hypochlorite; and
displaying usage of sodium hypochlorite on a display of the system controller.

5. The method of claim 4, further comprising the step of calculating an amount of chlorate, which has formed in the tank, based on the age of the sodium hypochlorite within the tank.

6. The method of claim 5, further comprising a chlorate alarm function in the alarm menu when an excessive chlorate level is reached.

7. The method of claim 6, further comprising setting the age of fill within the tank to zero upon refilling of the tank.

8. The method of claim 4, further comprising a vapor lock function within the system controller, and wherein the vapor lock function detects a vapor lock within a pump.

9. The method of claim 8, wherein upon refilling of the tank with sodium hypochlorite, further comprising pausing a feed rate value within the system controller prior to initiating a refilling of the tank, and then resuming a prior feed rate value after refilling of the tank is complete to avoid setting off the vapor lock function within the system controller.

10. The method of claim 4, further comprising:
generating at least two sodium hypochlorite curves, which show the percent concentrate the of sodium hypochlorite versus time; and
using the at least two sodium hypochlorite curves to calculate the percent concentrate of the sodium hypochlorite within the tank at a defined period of time.

11. The method of claim 4, further comprising:
converting the sodium hypochlorite to an amount of 100 percent pure chlorine; and
displaying the amount of 100 percent pure chlorine on the display of the system controller.

12. The method of claim 4, further comprising:
displaying a level of sodium hypochlorite within the tank, a weight of sodium hypochlorite within the tank, and a percent concentration sodium hypochlorite from a multi-point degradation chart; and
calculating an amount of 100 percent pure chlorine gas.

13. A system for monitoring sodium hypochlorite usage comprising:
a tank of known capacity, the tank located upon a scale, the scale being capable of generating a series of signals related to the weight of the tank when empty and at various levels of fill; and
a system controller having a display for displaying sodium hypochlorite usage, and wherein the system controller performs the following steps:
inputting into the system controller the series of signals from the scale relating to the weight of the tank when empty and at various levels of fill with sodium hypochlorite;
inputting into the system controller a concentration of the sodium hypochlorite upon filling of the tank;
tracking an age of the sodium hypochlorite within the tank to obtain a percent concentrate of sodium hypochlorite; and
displaying usage of sodium hypochlorite on a display of the system controller.

14. The system of claim 13, further comprising a sodium hypochlorite load key, and wherein the load key displays information and accepts input for a vapor alarm function, an excessive chlorate alarm function, a multi-point sodium hypochlorite degradation curve and a conversion to 100% pure chlorine display function.

15. The system of claim 13, wherein the system controller further includes an integrated time clock that allows computation of “loss in weight” feed rates and daily sodium hypochlorite usage data.

16. The system of claim 13, wherein the system controller further includes a 4-20 mA output signal capable of remotely transmitting remaining chemical, chemical feed rates or daily usage data.

17. The system of claim 13, further comprising;
a zero feed rate alarm, which compares a weight of supply tank measured by the scale with a minimum weight value and triggers an alarm if the measured weight is less than the minimum value; and

18. The system of claim 13, further comprising a metering pump for feeding chemical to a source of water wherein said system controller receives a valve related to a speed of the metering pump and calculates the amount of chemical required to provide a target amount of chemical of a desired diluted concentration for operating the metering pump at an optimum efficiency.

19. The system of claim 13, wherein the usage includes daily usage and an amount of sodium hypochlorite remaining in the tank.

20. A computer readable medium containing a computer program for monitoring sodium hypochlorite usage, wherein the computer program comprises executable instructions for:
providing a chemical system comprising:
a tank of known capacity, the supply tank located upon a scale, the scale being capable of generating a series of signals related to the weight of the tank when empty and at various levels of fill; and
a system controller for receiving the series of signals from the scale relating to the weight of the tank when empty and at various levels of fill;
inputting into the system controller the series of signals from the scale relating to the weight of the tank when empty and at various levels of fill with sodium hypochlorite;
inputting into the system controller a concentration of the sodium hypochlorite upon filling of the tank;
tracking an age of the sodium hypochlorite within the tank to obtain a percent concentrate of sodium hypochlorite; and
displaying usage of sodium hypochlorite on a display of the system controller.

21. The computer readable medium of claim 20, further comprising:
calculating an amount of chlorate which has formed in the tank based on the age of the sodium hypochlorite within the tank; and
setting off a chlorate alarm function in the alarm menu when an excessive chlorate level is reached.

22. The computer readable medium of claim 20, further comprising:
generating at least two sodium hypochlorite curves, which show the percent concentrate the of sodium hypochlorite versus time; and
using the at least two sodium hypochlorite curves to calculate the percent concentrate of the sodium hypochlorite within the tank at a defined period of time.

23. The computer readable medium of claim 20, further comprising:
converting the sodium hypochlorite to an amount of 100 percent pure chlorine; and
displaying the amount of 100 percent pure chlorine on the display of the system controller.

24. A method of monitoring sodium hypochlorite usage, comprising:
providing a chemical system comprising:
a tank of known capacity; and
a system controller for receiving the series of signals from an ultrasonic level sensor relating to various levels of fill of the tank;
inputting into the system controller the series of signals from the scale relating to the various levels of fill of the tank with sodium hypochlorite;
inputting into the system controller a concentration of the sodium hypochlorite upon filling of the tank;
tracking an age of the sodium hypochlorite within the tank to obtain a percent concentrate of sodium hypochlorite; and
displaying usage of sodium hypochlorite on a display of the system controller.
